(19) United States
(12) Patent Application Publication
(10) Pub. No.: US 2015/0164164 A1
(43) Pub. Date: Jun. 18, 2015

(54) Telescopic Artificial Tree Device with Interchangeable Parts

(71) Applicant: Glenn Trotter, Bradenton, FL (US)

(72) Inventor: Glenn Trotter, Bradenton, FL (US)

(21) Appl. No.: 14/455,264

(22) Filed: Aug. 8, 2014

Related U.S. Application Data
(60) Provisional application No. 61/865,441, filed on Aug. 13, 2013.

(51) Int. Cl. A41G 1/00; F21S 8/08; F21S 4/00; F21S 9/02; A47G 33/06; F21V 33/00

(52) U.S. Cl. CPC A41G 1/007; A47G 33/06; F21V 33/0028; F21S 4/001; F21S 9/02; F21S 8/08; F21W 2121/04

(57) ABSTRACT

Disclosed is a telescopic artificial tree with interchangeable branches and leaves. The artificial tree includes a telescopic trunk member that extends vertically upward from a base member with an imbedded lighting assembly, hydraulic motor, and other electrical components therein. The artificial tree further includes a plurality of branches with leaves thereon, wherein the branches and the leaves are adapted to illuminate via the lighting assembly imbedded in the base member. The branches are adapted to removably attach to the trunk member at various locations along the length thereof. In this way, the branches may be interchanged to alter the outward appearance of the tree. In one embodiment, the artificial tree resembles a palm tree. In another embodiment, the tree resembles a pine tree. Additionally, the present invention may include accessories that may be mounted on the branches.

### CROSS REFERENCE TO RELATED APPLICATION

This application claims the benefit of U.S. Provisional Application No. 61/865,441 filed on Aug. 13, 2013. The above identified patent application is herein incorporated by reference in its entirety to provide continuity of disclosure.

### BACKGROUND OF THE INVENTION

1. Field of the Invention

The present invention relates to an artificial tree. More specifically, the present invention pertains to an improved telescopic artificial tree that can be altered in appearance to resemble various types of trees, as desired by the user. The present invention may also comprise an LED lighting assembly so that the branches and the leaves may be illuminated. The present invention is suitable for indoor or outdoor use.

Many individuals have real plants and trees in their homes to decorate the interior of a room or to provide fresh indoor air. Having real trees in homes, however, can be inconvenient and unpractical. Real trees require regular maintenance and watering. If trees are not watered for a length of time, trees become dry and lose their ability to effectively absorb water. To prolong the life of the tree, the individual must remove the tree from the stand and saw a slice from the bottom of the trunk so that it can absorb more water. This is especially inconvenient if the tree is substantial in size. Real trees also tend to become messy as they drop leaves on the floor over time.

Real trees are also not ideal for individuals who suffer from allergies. The mold spores, pollens, herbicides, and fertilizers on the trees can trigger allergy symptoms, such as sneezing and congestion. To make the trees less inclined to trigger allergies, the user can hose down the tree before bringing it inside, but this can be impractical and inconvenient. Due to such inconveniences, some people may avoid having a tree in their home altogether.

The present invention is a telescopic artificial tree. The device includes a tree trunk member that is securely mounted to a base member. The base member comprises an imbedded lighting assembly, hydraulic motor, and other electrical components therein, depending upon embodiment. The trunk member may be adjusted vertically in height via a motor. In a preferred embodiment, a hydraulic motor is used. Additionally, the trunk member is adapted to receive a plurality of branches having leaves thereon. Each of the branches and the leaves comprise internal wiring that is connected to the lighting assembly in the housing. In this way, the branches and the leaves can illuminate when connected to the trunk member.

Further, the branches can attach and detach from the trunk member so that each of the branches may be replaced as needed. As such, the user may attach different types of branches and leaves to change the outward appearance of the artificial tree of the present invention. Therefore, the present invention is designed to increase the versatility of an artificial tree by providing one that can resemble various types of trees, and further one that provides tree branches and leaves that are easily interchangeable and removable.

2. Description of the Prior Art

Devices have been disclosed in the prior art that claim artificial outdoor trees. These include devices that have been patented and published in patent application publications. Some of these devices disclose a telescopic artificial tree that can be raised and lowered vertically. Other devices disclose an artificial palm tree. These devices, however, do not disclose a hydraulic motor and interchangeable branches and leaves. The foregoing is a list of devices deemed most relevant to the present disclosure, which are herein described for the purposes of highlighting and differentiating the unique aspects of the present invention, and further highlighting the drawbacks existing in the prior art.

Specifically, U.S. Pat. No. 5,712,002 to Reilly discloses a telescopic decorative tree having a telescopic pole and a plurality of lines spaced at regular intervals. The lines extend downwardly and outwardly in a Christmas tree shape. The lines comprise Christmas tree lights or other decorative items thereon. While the device of Reilly provides an artificial pine tree with illuminating means, the device of Reilly is limited in the fact that it is only adapted to resemble a pine tree, and more specifically, a Christmas tree. The present invention is adapted to convert from one type of tree to another, thereby providing versatility to the user. Thus, the present invention is suitable to be displayed year-around and in various locations. For instance, the present tree can be converted to a palm tree in the summer seasons and to a pine tree during the holidays.

Another device, U.S. Pat. No. 6,830,365 to Kao discloses an outdoor artificial tree having a trunk member and a plurality of branch members extending upwardly and outwardly therefrom. Each of the branch members comprises a plurality of twig members thereon. In some embodiments, the branch members further comprise optical members thereon. The tree is mounted in a cylindrical housing with imbedded light source and fan assembly. Unlike the present invention, however, the device of Kao cannot be adjusted in height, and does not comprise a hydraulic motor. The present invention comprises a hydraulic motor that allows the trunk member to extend and retract vertically. As such, the present invention may be automatically altered in size in a convenient manner.

U.S. Pat. No. 6,596,353 to Turner discloses an artificial palm tree having a base and a tree trunk extending upward therefrom. In a preferred embodiment, the tree trunk comprises a plurality of palm tree leaves at an upper end thereof. The tree trunk further comprises a plurality of joints that enable the trunk to bend in various directions. Similarly, U.S. Pat. No. 5,085,900 to Hamlett discloses an artificial palm tree comprising a tree trunk having a plurality of palm tree leaves at an upper end of thereof. Each of the leaves may be inserted through one of the ferrules disposed at various locations along the length of the trunk. Thereafter, the leaves may be secured via a fastener.

The foregoing Turner and Hamlett devices are directed toward artificial palm trees with removable branches. These devices, however, do not disclose branches with internal wiring so that the branches and leaves can illuminate. In contrast, the present invention comprises a plurality of branches having leaves thereon, wherein the branches and the leaves are adapted to illuminate. The present branches and leaves comprise a plurality of LED lights and internal wiring so that the LED lights can communicate with the lighting assembly imbedded in the base member of the present invention. The lighting assembly is powered via an internal or external power source, depending upon the embodiment.

Finally, U.S. Pat. No. 8,272,754 to Siu discloses an outdoor Christmas tree assembly comprising a cone-shaped frame. The frame may be divided into separate sections comprising annular frames and slanted lateral frames. The sections are detachably connected via a plurality of joints. The annular frames may comprise tree branches thereon, wherein each tree branch may include at least one set of lights, an electric socket, and an electric plug. The device of Siu, however is directed toward an artificial Christmas tree that cannot be adjusted in height. Further, the tree cannot be converted to a different type of a tree. The present invention provides a telescopic tree trunk that can be raised and lowered. Further, the branches and leaves can be easily installed and removed from the tree trunk to alter the outward look of the tree.

The devices disclosed in the prior art have several known drawbacks. These devices lack versatility and convenience because they do not comprise an electric motor or a hydraulic motor and removably attached branches and leaves. The present invention overcomes these limitations by disclosing an artificial tree with a trunk member that can be automatically raised and lowered via a hydraulic motor imbedded in the base member. Additionally, the present tree can be converted from one type of a tree to another, such as from a palm tree to a pine tree. In this way, the present invention provides a convenient way to maintain a plant in a home without the recurrent expense of a real tree. Furthermore, the present invention can be used over a long period of time and require very little clean up after each use.

It is therefore submitted that the present invention is substantially divergent in design elements from the prior art, and consequently it is clear that there is a need in the art for an improvement to artificial tree devices. In this regard, the instant invention substantially fulfills these needs.

### SUMMARY OF THE INVENTION

In view of the foregoing disadvantages inherent in the known types of artificial tree devices now present in the prior art, the present invention provides a new and improved telescopic artificial tree device with interchangeable parts wherein the same can be utilized for home dećor.

It is therefore an object of the invention to provide a new and improved telescopic artificial tree device that has all of the advantages of the prior art and none of the disadvantages.

Another object of the present invention is to provide a new and improved telescopic artificial tree device having a telescopic trunk member that can be automatically adjusted in height via a hydraulic motor.

Yet another object of the present invention is to provide a new and improved telescopic artificial tree device having interchangeable branches so as to convert the tree from one type of a tree to another.

Still yet another object of the present invention is to provide a new and improved telescopic artificial tree device having branches and leaves with LED lights and internal wiring that communicates with the lighting assembly.

Still yet another object of the present invention is to provide a new and improved telescopic artificial tree device that may be operated via a remote control.

Still yet another object of the present invention is to provide a new and improved telescopic artificial tree device having ornamental accessories.

Still yet another object of the present invention is to provide a new and improved telescopic artificial tree device that is suitable for indoor and outdoor use.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein the numeral annotations are provided throughout.

FIG. 1 shows a first embodiment of the present invention.

FIG. 2 shows a perspective view of a section of the trunk member of the present invention.

FIG. 3 shows top view of a section of the trunk member of the present invention.

FIG. 4 shows a close up view of the top portion of the first embodiment of the present invention.

FIG. 5 shows a second embodiment of the present invention.

FIG. 6 shows a close up view of the second embodiment of the present invention.

FIG. 7 shows a perspective view of the hydraulic drive system of the present invention.

FIG. 8A shows a bottom view of the control box of the present invention.

FIG. 8B shows a top view of the control box of the present invention.

FIG. 8C shows a rear view of the control box of the present invention.

### DETAILED DESCRIPTION OF THE INVENTION

References are made herein to the attached drawings. Like reference numerals are used throughout the drawings to depict like or similar elements of the telescopic artificial tree device with interchangeable parts. For the purposes of presenting a brief and clear description of the present invention, the preferred embodiment will be discussed as used for home dećor. The figures are intended for representative purposes only and should not be considered to be limiting in any respect.

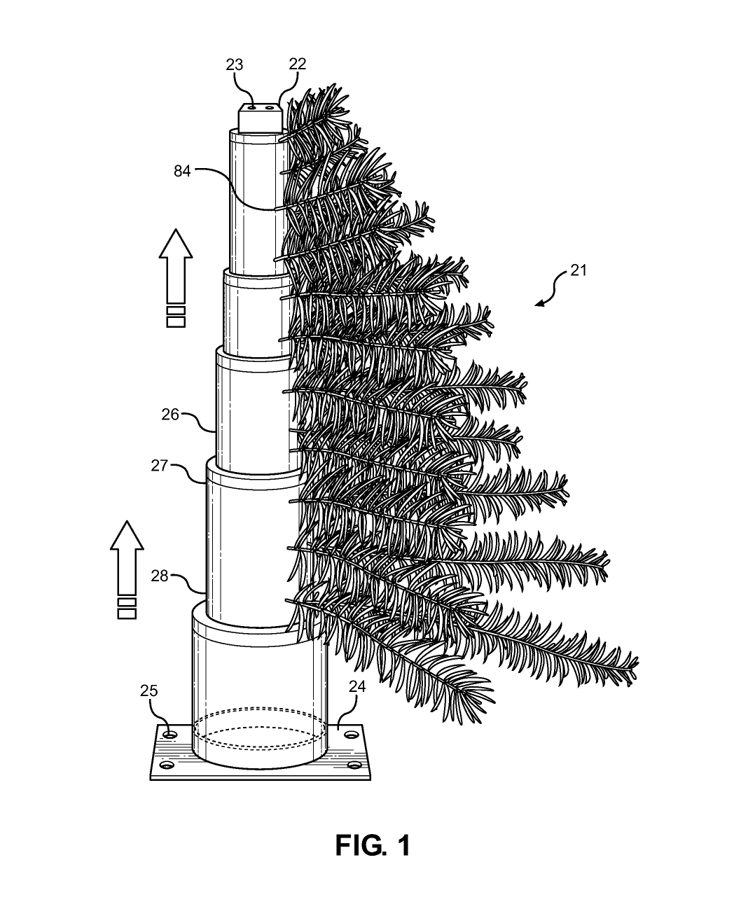

Referring now to FIG. 1, there is shown a first embodiment of the present invention. The illustrated embodiment of the artificial tree 21 comprises a rectangular base plate 24 with a telescopic trunk member extending vertically upward therefrom. It is contemplated that the base plate 24 is composed of rigid materials such as plastic or metal. The base plate 24 comprises an aperture 25 at each of the corners thereof. Each of the apertures 25 is adapted to receive a fastener therein, so that the artificial tree 21 may be secured onto the hydraulic drive system of the present invention or on another horizontal mounting surface, depending upon embodiment. In this way, the artificial tree 21 is prevented from tipping over during use. In some embodiments, the base plate 24 may further comprise printed designs thereon such that it blends with the surface on which it is mounted.

The telescopic trunk member is constructed of a plurality of cylindrical sections 26, wherein each of the sections include a hollow interior, an upper end 27, and a lower end 28. The specific number of sections 26 is not of primary relevance with regard to the intent of the present invention, which portends to provide an improved artificial tree having an adjustable height. Each of the sections 26 comprise a circular cross section with a diameter that is substantially uniform over its length. In some embodiments, however, the sections 26 may taper from the lower end 28 to the upper end 27. Each of the sections 26 vary in diameter, and are arranged so that the diameter of the sections 26 decreases from the bottommost section to the topmost section. Additionally, each of the sections 26 are connected so that the lower end 28 of one section is connected to an upper end 27 of an adjacent section via a connecting mechanism such as pins and brackets. As such, the lower end 28 of the bottommost section is attached to the base plate 24.

The trunk member is extended telescopically by moving each section in the direction of the section with the smallest diameter, or in the direction away from the base plate 24, until each of the sections jams against its adjacent sections. Conversely, the trunk member is collapsed by moving each section in the direction of the section with the largest diameter, or in the direction toward the base plate 24, until each of the sections jams to respective adjacent sections. In a preferred embodiment, the sections 26 extend or collapse via a hydraulic drive system embedded therein. In other embodiments, the sections 26 may extend or collapse via a manually operated pump.

The trunk member may be secured at a desired height via a locking mechanism such as pins and brackets. The trunk member is adapted to receive a plurality of branches 84 at various locations along its length. In the illustrated embodiment, the branches comprise artificial pine needles so that the tree 21 resembles an evergreen tree, such as a pine tree. Thus, the illustrated embodiment may be ideal for use during the holidays and can be decorated as a Christmas tree. In some embodiments of the present invention, the topmost section comprises a mounting assembly 22 with apertures 23 thereon. The mounting assembly 22 is adapted to attach a tree topper or other similar tree accessory thereon. Alternatively, the mounting assembly 22 may be used to attach the tree 21 to an overhead support so that the tree 21 does not topple over. Additionally, the mounting assembly 22 does not interfere in any way with the telescoping mechanism of the sections 26.

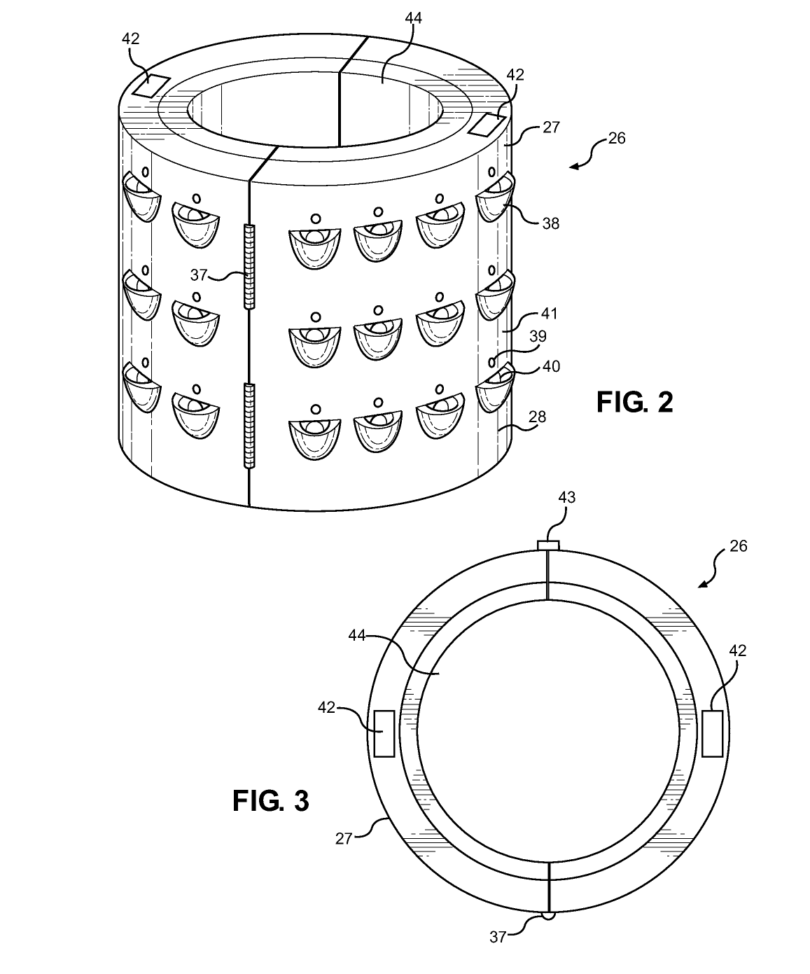

Referring now to FIG. 2, there is shown a perspective view of a section 26 of the trunk member of the present invention. The sections 26 are composed of fiberglass, plastic, aluminum, copper, steel, or other suitable materials. The sections 26 comprise a first and a second half that are joined together via a set of hinges 37 to form a cylindrical structure having a centralized opening 44, an upper end 27, a lower end 28, and a side wall 41 that extend therebetween. The side wall 41 comprises an outer surface and an inner surface, wherein the outer surface comprises a plurality of pockets 38 having a female connection 40 therein. The female connection 40 is adapted to receive a male connection disposed on each of the branches. The pockets 38 help the male connection wedge against the female connection 40 so that the branches do not easily disengage therefrom. If the male connection is properly inserted in the female connection 40, an indicator light 39 is adapted to illuminate. In a preferred embodiment, the indicator light 39 comprises an LED indicator light. Each of the indicator lights 39 corresponds to a single female connection 40 so that a user can easily identify a defective connection.

The indicator light 39 and the female connection 40 are connected to an integrated wiring module that is in communication with a power source. The wiring module is adapted to connect to a variety of functional modules such as the hydraulic drive system, lighting assembly, or power connection ports 42 so as to distribute electrical power from the power source to the functional modules in each of the sections 26. It is preferred that the wiring module of each of the sections 26 is connected and in communication with each other. The wiring module is preferably disposed along the inner surface of the side wall 41 so that it does not interfere with the female 40 and male connection disposed along the outer surface of the side wall 41.

Referring now to FIG. 3, there is shown a top view of the upper end 27 of a section 26 of the trunk member. As disclosed above, the section 26 comprises two halves that are hingedly attached to each other, so that the section 26 can open and close. The section 26 comprises a locking mechanism 43 so that the two halves may remain in a closed configuration. In the exemplary embodiment, the locking mechanism 43 comprises pins and brackets; however, the locking mechanism 43 may also comprise magnets, tabs, latches, and other such types of removable connectors.

Each of the halves of the section 26 further comprise power connection ports 42 at the upper end 27 thereof. The power connection ports 42 are in communication with the integrated wiring module so that electrical power from the power source is distributed to each of the sections 26. Additionally, the power connection ports 42 may be used to connect to the hydraulic drive system, lighting assembly, or other such functional modules, depending upon the embodiment.

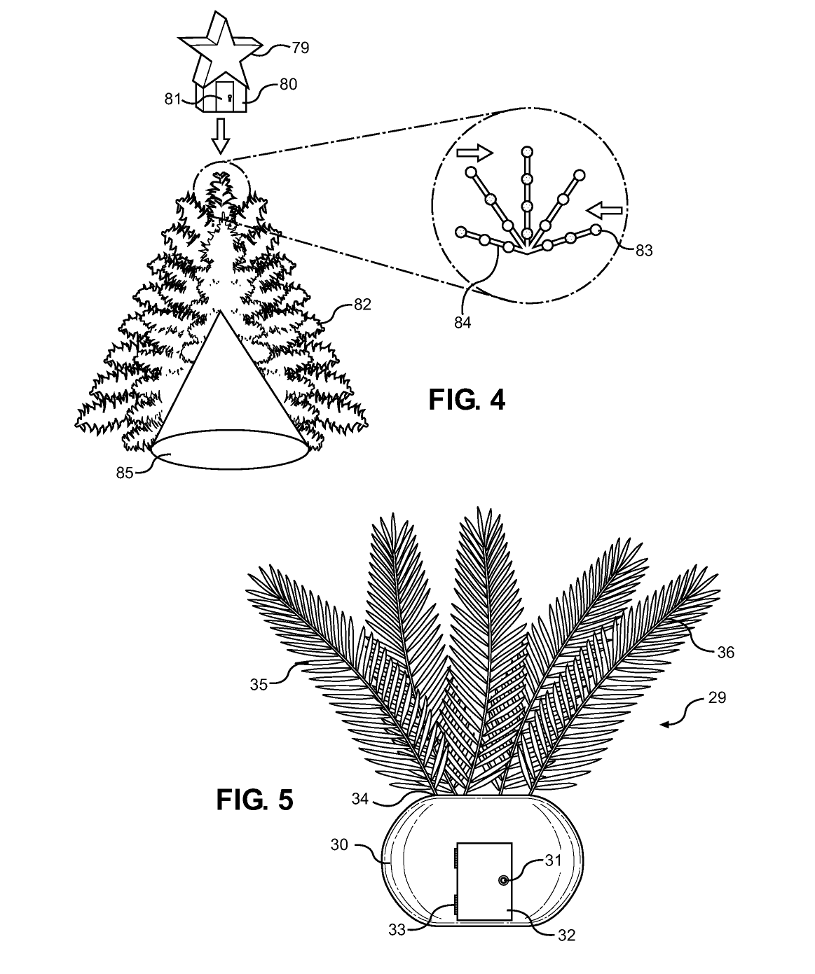

Referring now to FIG. 4, there is shown a close up view of the top portion of the first embodiment of the present invention. The first embodiment of the present invention comprises a topmost section 85 that is substantially conical in structure. In this way, the top portion of the first embodiment is pointed, similar to a pine tree or an evergreen tree. The topmost section 85 is composed of fiberglass, plastic, aluminum, copper, steel, or other suitable materials. The outer surface of the topmost section 85 comprise a plurality of female connections to accept the male connections disposed on each of the branches 84 having pine needles 82 thereon. Each of the branches 84 comprise a plurality of LED lights 83 disposed thereon. The LED lights may be white or colored, depending upon the embodiment. The LED lights 83 are connected to the lighting assembly via integrated wiring disposed in the hollow interior of the branches. The lights may be adapted to illuminate steadily, morph into different colors, or illuminate intermittently in a pattern.

The top portion of the first embodiment may further comprise a tree topper comprising an ornament 79 and a base housing 80 attached thereto. The ornament 79 may provide a user with imbedded electronic features to improve interoperability, interaction, and user convenience. In the illustrated embodiment, the ornament 79 takes the form of a hollow star, which may illuminate. The luminosity of the ornament is provided with an LED light source imbedded therein. Within the hollow cavity of the base housing 80 may comprise a plurality of electronic functions, such as a lighting assembly for the ornament, and an internal battery that may provide electrical power if an LED light source is utilized. Alternatively, the base housing 80 may connect to an external power source. The electronic functions may be accessible via a hingedly attached door 81 that is disposed on the base housing 80. Further, the base housing 80 is adapted to facilitate in mounting the tree topper to the artificial tree of the present invention.

Referring now to FIG. 5, there is shown a second embodiment of the present invention. The second embodiment of the artificial tree 29 of the present invention resembles a palm tree. The artificial tree 29 comprises a plurality of elongated branches 36 having palm leaves 35 thereon. Similar to the first embodiment, it is contemplated that the branches 36 are mounted on a telescopic trunk member. In the illustrated embodiment, the trunk member may be housed in a plant pot 30 having an upper opening 34 through which the branches 36 extend.

The plant pot 30 may be composed plastic, wood, stone, ceramic, or other suitable material. The plant pot 30 may comprise a door 32 that is attached via hinges 33. The door 32 enables a user to access the interior of the plant pot 30, which may comprise a control box. The door 32 may further comprise a lock 31 so that the control box is not easily accessible by guests, children, or other individuals who are not granted access to the control box.

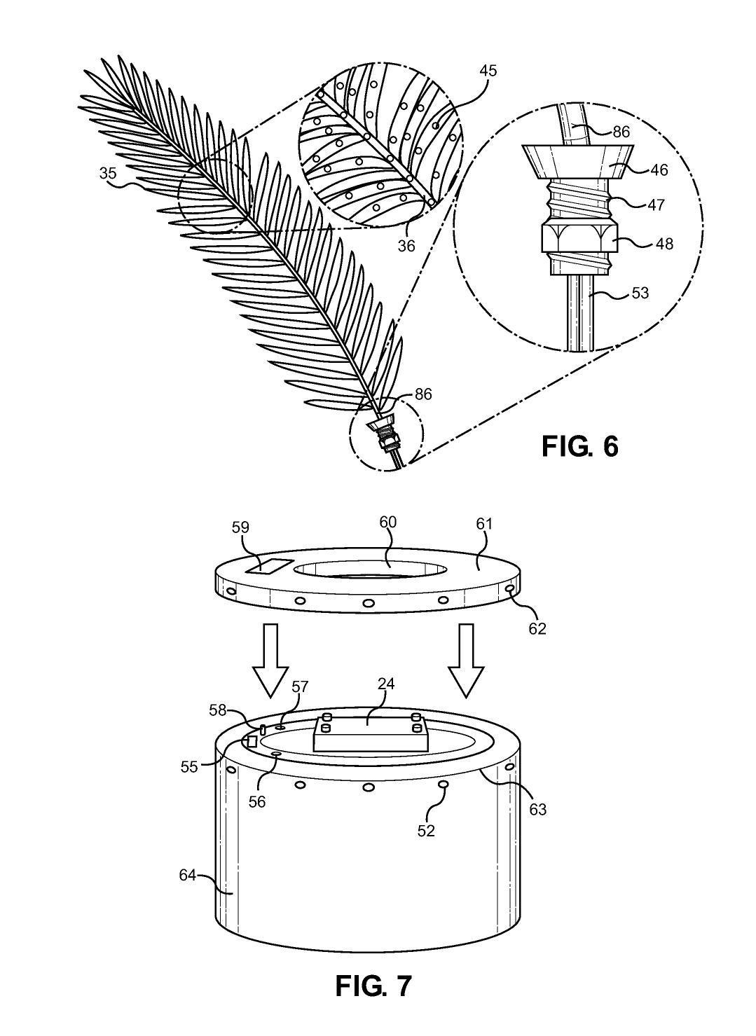

Referring now to FIG. 6, there is shown a close up view of the branch of the second embodiment of the present invention. The branch 36 comprises an elongated tube with a hollow cavity, a first end, and a second end. The branch 36 comprises a plurality of leaves 35, wherein the leaves 35 resemble palm leaves. The leaves 35 are attached from the first end and terminate short of the second end. Each of the branches 36 and the leaves 35 comprise a plurality of LED lights 45 disposed thereon. The LED lights may be white or colored, depending upon embodiment. The LED lights are connected to the lighting assembly via integrated wiring disposed in the hollow cavity of the branches 36. The lights 45 may be adapted to illuminate steadily, morph into different colors, or illuminate intermittently in a pattern.

The second end of the branch 36 comprises a male connection 86, which comprises a plate 46 that is attached to a fastener. The second end of the branch 36 is attached to an upper end of a plate 46. A lower end of the plate 46 is connected to a threaded bolt 47 having a nut 48 therearound. Each of the plate 46 and the bolt 47 comprise a centralized opening that is aligned with the hollow cavity of the branch 36, creating a single channel. The channel comprises integrated wiring 53 therein, which connects the LED lights 45 to a power source.

Referring now to FIG. 7, there is shown a perspective view of the hydraulic drive system of the present invention. The hydraulic drive system comprises a cylindrical housing 64 having a defined interior volume, an upper end 63 and a closed bottom end. In some embodiments, the upper end 63 may be open and comprise a ledge that extends toward the interior volume of the housing 64. The ledge comprises a control box 55, a fill hole 56, an air release 57, and a hydraulic pump 58. The interior volume of the housing may comprise: an electric motor that drives the hydraulic pump 58; valves, filters and piping to guide and control the hydraulic drive system; and hydraulic motor to drive the machinery. Additionally, the housing comprises the base plate 24 near the top end 63 so that the trunk member may attach thereto. Accordingly, the hydraulic drive system is disposed below the trunk member of the present invention. The hydraulic drive system is preferably connected to the topmost section so that when the topmost section is raised and lowered, rest of the sections will follow therewith.

The hydraulic drive system further comprises a circular lid 61 that is adapted to cover the upper end 63 of the housing 64. The lid 61 comprises a centralized opening 60 so as to allow the trunk member to extend therethrough when mounted to the base plate 24. The upper surface of the lid 61 comprises a door 59 that allows users to access the control box 55, fill hole 56, air release 57, and hydraulic pump 58 thereunder. As such, the lid 61 is placed over the housing 64 so that the door 59 is aligned with the control box 55, fill hole 56, air release 57, and hydraulic pump 58. The lid 61 further comprises a flange that extends downward therefrom. The flange comprises a plurality of apertures 62 along the perimeter thereof. The apertures 62 on the lid 61 directly align with a plurality of apertures 52 disposed at the upper end 63 of the housing. The apertures 62 and 52 are adapted to receive fasteners therethrough, such as bolts, so as to secure the lid 61 to the housing 64.

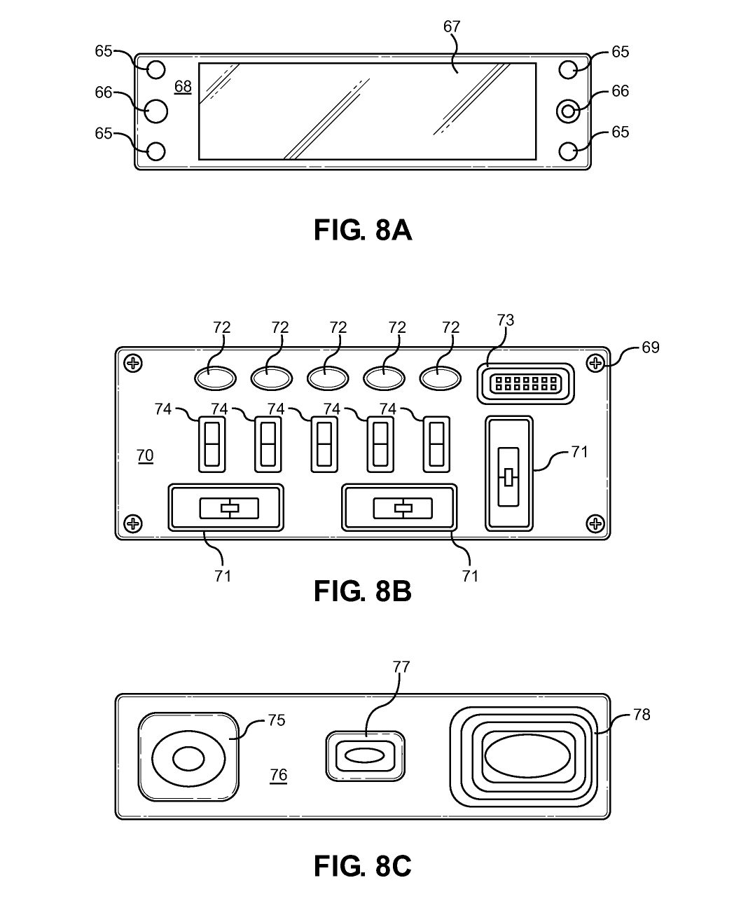

FIG. 8A shows a bottom view of the control box of the present invention. The control box is substantially rectangular in shape and comprises a bottom surface 68 having an aperture 65 at each of the corners thereof, wherein each of the apertures 65 is adapted to receive a fastener therethrough to secure a cover thereon. Additionally, the bottom surface 68 comprises a set of apertures 66 for mounting the control box onto a mounting surface such as the housing for the hydraulic drive system. The apertures 66 are located at the opposing ends of the bottom surface 68. The bottom surface 68 of the control box further comprises a power board 67 disposed between the apertures 66.

FIG. 8B shows a top view of the control box of the present invention. The top surface 70 of the control box comprises a plurality of apertures at each of the corners thereof, wherein the apertures directly align with apertures on the bottom surface of the control box. The apertures are adapted to receive fasteners 69 therethrough. The top surface 70 further comprises a plurality of power switches 74. Each of the power switches 74 communicate with functional modules such as the hydraulic drive system, lighting assembly, or a power connection port 73 so that electrical power is distributed when the power switch 74 is on. When the electrical power is distributed to a functional module and the functional module is properly actuated, one or more of the indicator lights 72 is adapted to illuminate. The top surface 70 of the control box further comprises a plurality of circuit breaker switches 71.

FIG. 8C shows a rear view of the control box of the present invention. The rear surface 76 of the control box may comprise a pump power connection port 75, indoor controller power connection port 77, and a main power connection port 78. It is contemplated that each of the connection ports 75, 77, 78 is connected to a power source via wires or cables that are in communication with a circuit board. The pump power connection port 75 provides electrical power to the electric motor that drives the hydraulic pump. The main power connection port 78 provides electrical power to the lighting assembly or another functional module, depending upon embodiment. Additionally, the indoor controller power connection port 77 provides electrical power to a remote controller unit.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above descriptions then, it is to be realized that the optimum dimensional relationships for the parts of the invention, to include variations in size, materials, shape, form, function, and manner of operation, assembly and use, are deemed readily apparent and obvious to one skilled in the art, and all equivalent relationships to those illustrated in the drawings and described in the specifications are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An artificial tree, comprising:
a telescopic trunk member comprising a plurality of cylindrical sections having an upper end, a lower end, and side wall that extend between said upper end and said lower end;
a plurality of branches having a first end and a second end;
said second end of said plurality of branches removably connected to said side wall of said plurality of cylindrical sections;
a plurality of leaves disposed between said first end and said second end of said plurality of branches;
a base plate attached to a lower end of said trunk member.

2. The artificial tree of claim 1, further comprising a hydraulic drive system for extending and collapsing said telescopic trunk member, wherein said hydraulic drive system comprises:
a housing having a defined interior volume, an upper end and a bottom end;
a ledge that extends toward said interior volume of said housing at said upper end;
a control box, a fill hole, an air release, and a hydraulic pump disposed on said ledge;
an electric motor, valves, filters, piping, and a hydraulic motor disposed in said interior volume of said housing;
wherein said electric motor drives said hydraulic pump;
wherein each of said valves, filters and piping guide and control said hydraulic drive system;
said base plate disposed at said upper end of said housing.

3. The artificial tree of claim 2, wherein said hydraulic drive system further comprises:
a circular lid that is adapted to cover said upper end of said housing;
said lid having a centralized opening, an upper surface, and a defined perimeter;
wherein said opening of said lid is adapted to receive said trunk member therethrough;
a door on said upper surface of said lid;
a flange that extends downward from said perimeter of said lid;
a plurality of apertures spaced at regular intervals on said flange;
a plurality of apertures spaced at regular intervals on a perimeter of said upper end of said housing;
said plurality of apertures of said flange adapted to directly align with said plurality of apertures of said housing;
each of said plurality of apertures of said flange and said plurality of apertures of said housing adapted to receive a fastener therethrough, thereby securing said lid to said housing.

4. The artificial tree of claim 2, wherein said control box comprises a top surface, a bottom surface, and a rear surface;
said top surface comprising a set of apertures, a plurality of power switches, a power connection port, a plurality of indicator lights, a plurality of circuit breaker switches
said bottom surface comprising a power board, a first set of apertures, and a second set of apertures;
wherein said first set of apertures are adapted to receive fasteners therethrough to secure a cover thereon;
wherein said second set of apertures are adapted to receive fasteners therethrough to secure said control box to a mounting surface;
wherein said second set of apertures directly align with said set of apertures of said top surface;
said rear surface comprising a pump power connection port, an indoor controller power connection port, and a main power connection port.

5. The artificial tree of claim 1, further comprising a pot with an interior volume that is adapted to house said telescopic trunk member.

6. The artificial tree of claim 1, wherein said plurality of leaves comprise palm leaves.

7. The artificial tree of claim 1, wherein said plurality of leaves comprise pine needles.

8. The artificial tree of claim 1, further comprising a light assembly connected to each of said plurality of branches and said plurality of leaves.

9. The artificial tree of claim 8, wherein said lighting assembly comprises LED lights.

10. The artificial tree of claim 1, wherein said side wall of each of said plurality of cylindrical sections comprise:
a plurality of female connections that is connected to an integrated wiring module that is in communication with a power source;
a plurality of indicator lights for each of said plurality of female connections.

11. The artificial tree of claim 10, wherein said second end of said plurality of branches comprise a male connection;
said male connection comprising a plate and a fastener attached thereto;
each of plurality of branches, said plate, and said fastener having a centralized opening having an integrated wiring therethrough;
said male connection adapted to removably connect to each of said plurality of said female connections.

12. The artificial tree of claim 1, wherein said upper end of each of said plurality of cylindrical sections comprise a ledge having at least one power connection port.

13. The artificial tree of claim 1, wherein said plurality of cylindrical sections comprise:
a first half section and a second half section attached via hinges;
wherein said first half section and said second half section are relatively movable between an open position and a closed position;
wherein said first half section and said second half section can be secured in said closed position via a locking mechanism.

14. The artificial tree of claim 13, wherein said locking mechanism comprises a set of pins and brackets.

15. The artificial tree of claim 1, further comprising a tree topper:
said tree topper comprising an ornament and a base housing attached thereto;
wherein said ornament is adapted to illuminate;
wherein said base housing connects to a power source.

16. The artificial tree of claim 15, wherein said ornament is a star.
